(19) United States
(12) Patent Application Publication
(10) Pub. No.: US 2004/0023053 A1
(43) Pub. Date: Feb. 5, 2004

(54) Elastic film

(76) Inventor: Thomas Nicola, Spicheren (FR)

Correspondence Address: KENYON & KENYON, ONE BROADWAY, NEW YORK, NY, 10004, US

(21) Appl. No.: 10/276,606

(22) PCT Filed: Mar. 16, 2001
(86) PCT No.: PCT/EP01/03030

(30) Foreign Application Priority Data
May 18, 2000 (EP) 100 24 707.5

(51) Int. Cl. B32B 27/08

(52) U.S. Cl. 428/515; 428/523

(57) ABSTRACT

The invention relates to an elastic, substantially non-stretched film produced from olefinic materials that is completely free of PVC and that is yet adapted to the requirements of a film, such as a film for medical purposes, for example for heat sterilization. The inventive film has elastic properties up to a certain point that depend on the film's thickness, that means no permanent deformation can be observed. When the tensile stress is further increased, the film is deformed, that is it shows a plastic behavior until it finally tears or breaks. The transition is fluid since, unlike conventional films, the inventive film has no negative increase in the yield point. The increase in the yield point is ≧0. The invention further relates to the use of the inventive films, for example in the field of medical engineering, and to bags for medical purposes that comprise at least one film according to the invention.

The present invention relates both to elastic non-PVC sheets which, when subjected to heat sterilization, are essentially stable in shape, and to the application thereof, for example, in the field of medical technology. The present invention relates further to bags for medical use comprising at least one such sheet.

There is a need in the field of medicine for sheets for medical bags that are capable of withstanding pressure loading for up to several days when used, for example, as IV bags (bags used for intravenously-administering medications), in pressurized cuffs, or as powder concentrate bags, in which pressure is exerted from the inside during use.

In most cases, this type of sheet, which is designed to be employed in bags for medical use is, conventionally, constructed of polyvinyl chloride (PVC). The use of PVC, however, is attended with certain disadvantages. Firstly, PVC sheet contains a plasticizer that can be released and—in the case of usage of the sheet in bags for medical use—can diffuse into the medication solution contained inside the bag. Secondly, the heat-sealing of PVC bags produces hydrochloric acid. Thirdly, PVC tends to absorb the medications contained in the infusion solutions.

For the aforementioned reasons, therefore, efforts have been made to replace PVC with other synthetic materials. DE 195 15 254, for example, discloses multi-layer non-PVC sheets that feature a construction containing at least three layers comprising two external support layers and one middle layer. Bags produced from such sheets are not capable of withstanding pressure loading without undergoing permanent alteration of shape. In the present specification, the term “non-PVC sheets” is used to denote sheets that do not contain any PVC.

Oriented or drawn sheets exhibit good mechanical characteristics such as, for example, stability under pressure and are, if employed in a multi-layer construction, impermeable to water vapour. Oriented sheets, however, shrink when heated and cannot therefore be heat-sterilized.

The object of the present invention, therefore, is the preparation of sheets that do not exhibit the disadvantages of prior art sheets. It is proposed, in particular, that sheets be prepared, from which bags and other containers, of stable shape and, preferably, heat-sterilizable, can be produced. It is preferred that the sheets be biocompatible.

This object will be satisfied by the embodiments distinguished in the claims.

It is proposed more particularly that a substantially non-drawn, elastic, non-PVC sheet be produced, whose stress-strain diagram does not exhibit a point at which the slope of the curve is <0.

Up to a predetermined load or predetermined pressure, the proposed sheet, being of predetermined thickness, does not, therefore, undergo any significant lasting alteration of its shape, and behaves substantially elastically. Whenever a load above this limit is imposed, the proposed sheet resists the external load up to the point of ripping with a resistance that is at least constant, and preferably steadily increasing, in respect of which the proposed sheet distends in a plastic, i.e. fluid manner.

The figures show:

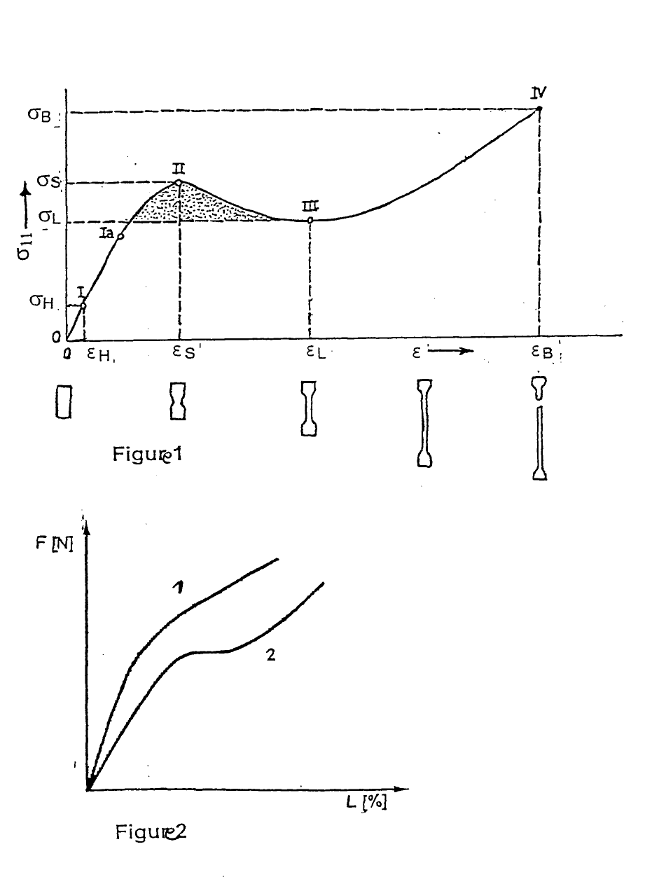

FIG. 1 shows schematically a stress-strain diagram of a conventional thermoplastic sheet.

FIG. 2 shows schematically the stress-strain diagram of two sheets that exhibit the proposed characteristics.

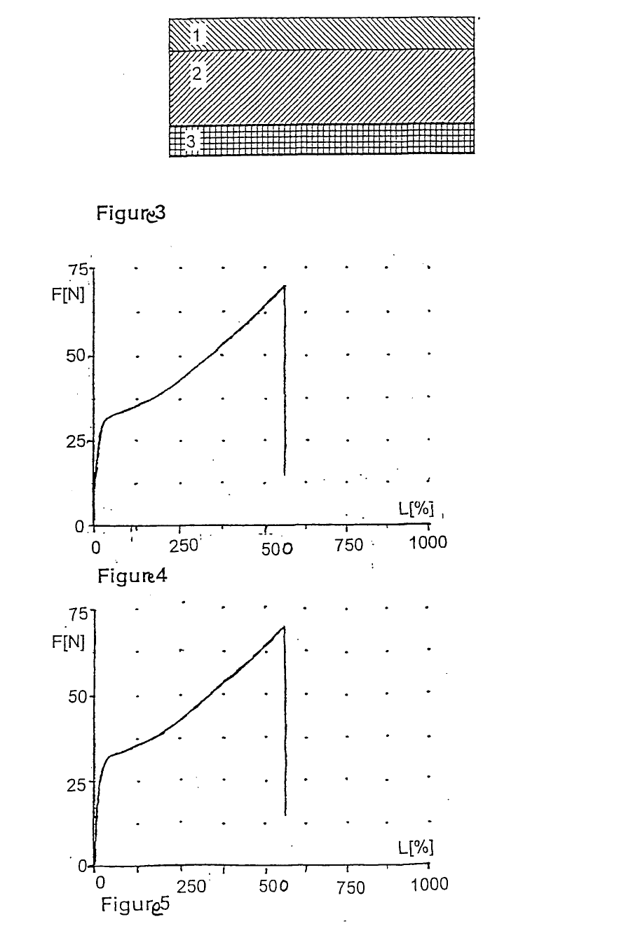

FIG. 3 is a schematic section through a multi-layer embodiment of a proposed sheet.

FIG. 4 shows the stress-strain diagram of a single-layer sheet in accordance with Example 1.

FIG. 5 shows the stress-strain diagram of a triple-layer sheet in accordance with Example 2.

FIG. 1 shows the stress-strain diagram for a conventional thermoplastic material. Conventional non-drawn thermoplastic sheets can exhibit a certain shape stability and elasticity up to a threshold value denoted by the upper limit of yield stress σₛ. Further in the stress-strain diagram, a maximum II, the so-called yield point, is surpassed, this point being defined by the upper limit of yield stress σₛ [N/mm²] (from the stress force Fₛ [N] normalized to the area) and upper flow limit ε_{S}. Beyond the yield point, the deformation continues to increase while, however, the tensile stress diminishes until a minimum III is surpassed. Conventional thermoplastic materials, therefore, after the yield point (in the present example: Maximum II) has been surpassed, exhibit a curve featuring regions of negative slope, i.e. after the yield point has been surpassed, a reduction of stress occurs together with an increased distension of the sheet which, being unrelated to increased tensile loading, occurs even in the presence of tensile loading that is less than that which was required to reach the yield point.

In tensile experiments, the yield point can, in general, be identified by a constriction of the test material, this behaviour owing, at the molecular level, to an alignment of the polymer chains in the direction of draw. Such constriction of the sheet, or, rather, alignment of the polymer chains, is irreversible, the implication being that the sheet does not regain its original shape after tensile loading has been reduced. Thus, the yield point represents the limit value for the load, up to which point a material can react elastically, i.e. reversibly to a load, or, rather, beyond which the material deforms plastically, i.e. essentially irreversibly.

It is proposed that the expression “yield point” denote this boundary value between elastic and plastic behaviour, and moreover, that this limit value not be related to a maximum along the stress-strain curve. As will be described hereunder, it is proposed that the transition between elastic and plastic behaviour be fluid, the stress-strain curve not exhibit a maximum for a yield point, i.e. the yield point (a) cannot be recognized in the stress-strain diagram (b) can be recognized by a change in the slope of the curve given the same indicators of slope or (c) constitutes a reversal point of the curve, so that the slope of the curve equals 0 at the reversal point.

FIG. 2 shows schematically the curves of the stress-strain diagrams of two examples of the proposed sheet, which do not show a maximum. In FIG. 2, although the curve indicated by the numeral 1 exhibits neither a maximum nor a reversal point, the slope of the curve changes after a limit value has been surpassed. The curve designated by the numeral 2 exhibits a reversal point at which the slope equals 0. Neither of the curves exhibits a point at which the slope of the curve is negative.

Even the proposed sheets can, after a limit value has been surpassed, exhibit an irreversible constriction, which implies that, even if the tensile load is reduced, such sheets cannot regain their original shape. It is therefore proposed that plastic behaviour begin only after a threshold value or a limit value has been surpassed, up to which the material exhibits essentially no lasting change of shape, i.e. behaves in an essentially elastic manner.

It is proposed that the expression “essentially elastic behaviour” signify that a material, for example a sheet, following removal of a load, reassumes its original shape, i.e. does not undergo, essentially, any permanent change of shape.

It is proposed that the expression “essentially no permanent change of shape” signify a change of shape no greater than 20%, and preferably no greater than 15%. In this respect, it is proposed that the expression “change of shape” encompass both a deformation or deviation from the original geometric shape, i.e. a deformation, and a pure elongation without deformation of shape.

It is proposed that a stress-strain diagram be measured by means of a tensile test, for example in accordance with DIN 53 455 or DIN 53 504. In such a test, a piece of material to be tested, having a defined length L_{O} and an area of cross section A_{O}, is secured in a traction machine and stretched at constant speed up to ripping. The force F, which has been required up to this point, is recorded as a function of the given length of the test material. The nominal tensile stress determined in each phase of the experiment σ=F/A_{O} is then applied in a stress-strain diagram against the given elongation ε=(L−L_{O})/L_{O}. Where test materials of standard length and area of cross section are utilized, the required force F can be applied instead of the tensile stress. In accordance with DIN 53 504, the relationship between the tensile force and the change in the length of the test piece up to ripping during the course of the tensile test is entered in a force-change-of-length curve.

The proposed sheet comprises preferably at least one semicrystalline polymer or synthetic material. It is proposed that the semicrystalline synthetic material be preferably mostly amorphous, in respect of which the expression “mostly amorphous synthetic material” signifies a polymer compound having a degree of crystallisation of <50%.

The expression “synthetic material” is understood to signify the proposed polymer materials whose major component comprises macromolecular organic compounds or polymers, in respect whereof the polymer materials can be homopolymers, copolymers, mixtures or blends.

Preferred are flexible polyolefins based on polyethylene (PE) and/or polypropylene (PP), such as WL 203, WL 209 and WL 116 from Huntsman Corp. Also preferred are styrene-isoprene-styrene (SIS) block copolymers and mixtures and blends thereof, such as Hybrar® from Kuraray. The aforesaid polymers can be employed as block copolymers, random copolymers, graft copolymers and/or mixtures or blends.

The present invention also relates to the use of the aforementioned synthetic materials as sheet.

The proposed sheet can exhibit a single or multi-layer construction.

In accordance with one embodiment of the present invention, the proposed sheet comprises a single layer. In such a case, the material selected for the sheet should permit characteristics of the sheet that may be desirable at any given time, such as, for example, the capability to withstand heat sterilization and the capability to form a water vapour barrier, to be provided from the outset by a single layer of sheet. The preferred material for a single-layer sheet can, in particular, be selected from a group of materials based on SIS block copolymers.

In accordance with a further embodiment, the proposed sheet is constructed from a plurality of layers. In a multi-layer construction, it is preferred that at least the external layers exhibit a Vicat softening point above approx. 121° C., while the internally-situated layers may exhibit a lower softening point. The thickness of the individual layers is not of crucial importance. Layers having a softening point above 121° C. should, preferably, have a thickness from 10 to 100 μm, and most preferably from 10 to 50 μm. An internally-situated layer having a softening point below 121° C. should, preferably, be no less than 60 μm thick. In addition, should a multi-layer construction be employed, a so-called sealing layer can, wherever necessary, be prepared, and this disposed preferably as an external layer. Such a sealing layer is capable of either enabling or improving the bonding of the proposed sheet. Generally speaking, polymers, capable of withstanding solutions, are used for the sealing layer, since the latter will, following manufacture of the bag, be located in the internal region of a bag produced from the proposed sheet. Particularly preferred for use in multi-layer sheets are materials which, in respect of the individual layers, are based on polypropylene and polyethylene, and if necessary, in combination with layers of SIS copolymers.

A proposed sheet having a multi-layer construction is manufactured preferably by means of co-extrusion.

The proposed sheets are—aside from an orientation of less than approx. 2% that is introduced during manufacture—neither oriented nor drawn and therefore hardly shrink when heated.

The proposed sheets can, furthermore, preferably be sterilized by means of heat. Medical equipment and containers are normally subjected to sterilization in autoclaves in the presence of steam at approx. 121° C. The shape of the proposed single or multi-layer sheets is preferably stable at such temperatures and under autoclave conditions.

The softening temperature for the proposed polymer and synthetic materials is determined in accordance with Vicat VST/A/50. i.e. is defined as being that temperature, at which a loaded steel pin of 1 mm² cross section can be pressed to a depth of 1 mm into a test body of synthetic material whose temperature is increasing (see DIN ISO Standard 306, ASTM D1525). The softening temperature in most cases is significantly lower than the temperature at which the polymer substance would completely reach a quasi-fluid state.

The proposed sheets exhibit preferably a thickness of no less than 50 μm. It is especially preferable if the proposed sheets exhibit a thickness from 50 to 500 μm.

In addition, it is preferred that the proposed sheets permit the passage of little or no water vapour; i.e. they form a barrier against water vapour, and even in the presence of cold exhibit good impact resistance. It is furthermore preferred that the proposed sheets be transparent.

Preferred embodiments of the proposed sheets are substantially free of slip additives, plasticizers, anti-blocking agents, anti-static agents or fillers.

The proposed sheets can be manufactured using conventional forming processes, such as sheet extrusion, that are capable of producing flat or tubular sheet.

The present invention relates furthermore to the application of the proposed sheet in the medical sector, and more particularly to the use thereof as input material for the manufacture of bags for medical use and multi-chamber bags that are utilized, for example, for storing infusions and similar liquids.

The present invention relates furthermore to bags for medical use that comprise at least one proposed sheet. Such bags are preferably impact resistant.

### EXAMPLES

### Example 1

### Single-Layer Sheet

A monosheet 200 μm thick was manufactured from Hybrar® 7125F (styrene-isoprene-styrene-copolymer, produced by Kuraray Co. Ltd.) and the force-elongation curve measured in accordance with DIN 53 504. This curve, shown in FIG. 4, does not exhibit a point with negative slope. In addition, the sheet behaves elastically up to a threshold point.

### Example 2

### Multi-Layer Sheet

A triple-layered sheet 200 μm thick was produced by means of co-extrusion. The construction of the sheet is schematically illustrated in FIG. 3. Layer 1, which exhibits a thickness of 30 μm, comprises the flexible Polyolefin WL 116 manufactured by Huntsman Corp. Layer 2 exhibits a thickness of 140 μm and comprises the flexible polyolefin WL 203 manufactured by Huntsman Corp. The third layer again exhibits a thickness of 30 μm and comprises 85% by weight PP232cs198 (polypropylene rubber, manufactured by Huntsman Corp.) and 15% by weight Kraton® G1652 (styrene-ethylene/butylene (SEB)-copolymer) manufactured by Shell.

FIG. 5 illustrates the tensile-elongation curve following sterilization at 121° C. Again, the force-elongation curve measured in accordance with DIN 53 504 does not exhibit a point with negative slope. In addition, the sheet behaves elastically up to a threshold value which, in the present example, is 30 N.

1. Substantially non-drawn, elastic non-PVC sheet whose stress-strain-diagram exhibits no point at which the slope of the curve <0.

2. Sheet in accordance with claim 1 that can be sterilized by means of heat.

3. Sheet in accordance with claim 1 or 2 exhibiting a Vicat softening point of >121° C.

4. Sheet in accordance with one or more of the foregoing claims comprising at least one semicrystalline thermoplastic synthetic material.

5. Sheet in accordance with one or more of the foregoing claims, comprising at least one thermoplastic elastomer and/or a flexible polyolefin.

6. Sheet in accordance with one or more of the foregoing claims, comprising at least one polymer selected from a group comprising flexible polyolefins based on polyethylene and/or on polypropylene, as well as styrene-isoprene-styrene-block copolymers and/or mixtures and/or blends thereof.

7. Sheet in accordance with one or more of the foregoing claims comprising a single layer.

8. Sheet in accordance with one or more of the claims 1 to 6, comprising a plurality of layers.

9. Sheet in accordance with one or more of the foregoing claims exhibiting a thickness of between 50 and 500 μm.

10. Use of a sheet in accordance with one or more of claims 1 to 9 in the manufacture of bags for medical use.

11. Bags for medical use, comprising at least one sheet in accordance with one or more of claims 1 to 9.
